(19) United States
(12) Patent Application Publication
(10) Pub. No.: US 2025/0267566 A1
(43) Pub. Date: Aug. 21, 2025

(54) NETWORK SLICE ENHANCEMENTS

(71) Applicant: Apple Inc., Cupertino, CA (US)

(72) Inventors: Vivek G. Gupta, San Jose, CA (US); Anikethan Ramakrishna Vijaya Kumar, Mysuru (IN); Basant Kumar, Bangalore (IN); Nirlesh Koshta, Bangalore (IN); Shashanka Totadamane Ramappa, Shivamogga (IN); Sridhar Prakasam, Fremont, CA (US)

(21) Appl. No.: 19/056,612

(22) Filed: Feb. 18, 2025

(30) Foreign Application Priority Data
Feb. 19, 2024 (IN) 202411011380

(51) Int. Cl. H04W 48/18; H04W 28/02; H04W 28/24

(52) U.S. Cl. CPC H04W 48/18; H04W 28/021; H04W 28/24

(57) ABSTRACT

Disclosed are methods, systems, and computer-readable media to perform operations for network slice enhancements. The operations include detecting a Tracking Area (TA) change due to a handover during a mobility registration update procedure (MRU) of a user equipment (UE) in a 5G Mobility Management (5GMM)-CONNECTED state, in response to detecting the TA change and a new TA being a part of a registration area associated with the UE during the MRU procedure, continuing to perform the MRU procedure; in response to detecting the TA change and the new TA being outside of the registration area associated with the UE during the MRU procedure, remaining in the 5GMM-CONNECTED state; aborting the MRU procedure; and re-initiating a new MRU procedure.

### CROSS-REFERENCE TO RELATED APPLICATIONS

The present application claims priority to India application No. 202411011380, filed on Feb. 19, 2024, entitled “NETWORK SLICE ENHANCEMENTS,” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time-division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

Network slice enhancements refer to improvements, optimizations, or additional capabilities introduced into network slices within a 5G network. The enhancements aim to enhance the performance, flexibility, scalability, and functionality of network slices to better support diverse use cases, applications, and service requirements.

### SUMMARY

According to one innovative aspect of the present disclosure, a method includes detecting a Tracking Area (TA) change due to a handover during a mobility registration update (MRU) procedure of a user equipment (UE) in a 5G Mobility Management (5GMM)-CONNECTED state, and in response to detecting the TA change and a new TA being a part of a registration area associated with the UE during the MRU procedure, continuing to perform the MRU procedure.

Other aspects include systems, non-transitory computer storage media, apparatuses, baseband processors, and computer programs for performing the aforementioned method.

The innovative method can include other optional features. For example, in some implementations, the method further includes in response to detecting the TA change and the new TA being outside of the registration area associated with the UE during the MRU procedure, continuing to be in the 5GMM-CONNECTED state; aborting the MRU procedure; and re-initiating a new MRU procedure.

According to another innovative aspect of the present disclosure, a method includes determining that a route selection descriptor (RSD) of a user equipment (UE) Route Selection Policy (URSP) rule is invalid and none of Single Network Slice Selection Assistance Information (S-NSSAIs) associated with the RSD are included in either an allowed Network Slice Selection Assistance Information (NSSAI) or a partially allowed NSSAI; and in response to determining that the RSD of the URSP rule is invalid and none of the S-NSSAIs associated with the RSD are included in either the allowed NSSAI or the partially allowed NSSAI, initiating an MRU procedure to add one or more S-NSSAIs associated with the RSD to either the allowed NSSAI or the partially allowed NSSAI.

Other aspects include systems, non-transitory computer storage media, apparatuses, baseband processors, and computer programs for performing the aforementioned method.

The innovative method can include other optional features. For example, in some implementations, the one or more S-NSSAIs are in a configured NSSAI.

According to another innovative aspect of the present disclosure, a method includes determining that a first Single Network Slice Selection Assistance Information (S-NSSAI) is subject to a first Network Slice Specific Authentication and Authorization (NSSAA) procedure; determining that the first S-NSSAI is one of subscribed S-NSSAIs of a user equipment (UE); and in response to determining that the first S-NSSAI is subject to the first NSSAA procedure and the first S-NSSAI is one of the subscribed S-NSSAIs of the UE, selecting the first S-NSSAI as an alternative S-NSSAI; and performing the first NSSAA procedure for the alternative S-NSSAI.

Other aspects include systems, non-transitory computer storage media, apparatuses, baseband processors, and computer programs for performing the aforementioned method.

The innovative method can include other optional features. For example, in some implementations, the method further includes determining that a second S-NSSAI is subject to a second NSSAA procedure triggered by a Access and Mobility Management Function (AMF); determining that the second S-NSSAI is not one of subscribed S-NSSAIs of a UE, in response to determining that the second S-NSSAI is subject to the second NSSAA procedure triggered by the AMF and the second S-NSSAI is not one of subscribed S-NSSAIs; aborting the second NSSAA procedure for the second S-NSSAI; and determining not to select the second S-NSSAI as the alternative S-NSSAI.

In some implementations, a network slice associated with the alternative S-NSSAI meets minimum requirements for one or more services and Service Level Agreements (SLAs) enabled by a network slice associated with an S-NSSAI to be replaced.

In some implementations, the method is performed using Operations, Administration, and Maintenance (OAM), Policy Control Function (PCF), or Network Slice Selection Function (NSSF).

According to another innovative aspect of the present disclosure, a method includes determining that a Single Network Slice Selection Assistance Information (S-NSSAI) is included in a partially allowed Network Slice Selection Assistance Information (NSSAI); determining whether a current Tracking Area Identity (TAI) is in a list of Tracking Areas (TAs) for which the S-NSSAI is rejected or the UE is outside a Network Slice-Area of Service (NS-AoS) of the S-NSSAI; in response to determining that the S-NSSAI is included in the partially allowed NSSAI and determining that the current TAI is in the list of TAs for which the S-NSSAI is rejected or the UE is outside an NS-AoS of the S-NSSAI, determining not to initiate a UE-requested Packet Data Unit (PDU) session establishment procedure for the S-NSSAI.

Other aspects include systems, non-transitory computer storage media, apparatuses, baseband processors, and computer programs for performing the aforementioned method.

The innovative method can include other optional features. For example, in some implementations, the method further includes determining whether the current TAI is in the list of TAs for which the S-NSSAI is allowed; and in response to determining that the S-NSSAI is included in the partially allowed NSSAI and determining that the current TAI is in the list of TAs for which the S-NSSAI is allowed, initiating the UE-requested PDU session establishment procedure or a UE-requested PDU session modification procedure for the S-NSSAI.

In some implementations, the method further includes determining that a PDU session is established for the S-NSSAI included in the partially allowed NSSAI; detecting a change in the current TAI; determining that the current TAI is in the list of TAs for which the S-NSSAI is rejected or the UE is outside the NS-AoS of the S-NSSAI; in response to determining that the PDU session is established, detecting a change of the current TAI, and determining that the current TAI is in the list of TAs for which the S-NSSAI is rejected or the UE is outside the NS-AOS of the S-NSSAI, maintaining 5G system Session Management (5GSM) contexts for the established PDU session.

In some implementations, the method further includes determining that a PDU session is established for the S-NSSAI in the partially allowed NSSAI; detecting a change in the current TAI; determining that the current TAI is in the list of TAs for which the S-NSSAI is allowed; in response to determining that the PDU session is established, detecting a change of the current TAI, and determining that the current TAI is in the list of TAs for which the S-NSSAI is allowed, initiating a service request procedure to reestablish a user plane for the established PDU session.

According to another innovative aspect of the present disclosure, a method includes determining that a Single Network Slice Selection Assistance Information (S-NSSAI) is not available as indicated by Single Network Slice Selection Assistance Information (S-NSSAI) time validity information; determining a state of the UE, and in response to determining that the S-NSSAI is not available and determining that the UE is in a 5G Mobility Management (5GMM)-CONNECTED state, initiating a UE-requested Packet Data Unit (PDU) session release procedure to release one or more PDU sessions associated with the S-NSSAI.

Other aspects include systems, non-transitory computer storage media, apparatuses, baseband processors, and computer programs for performing the aforementioned method.

The innovative method can include other optional features. For example, in some implementations, the method further includes in response to determining that the S-NSSAI is not available and determining that the UE is in a 5GMM-IDLE state or in a 5GMM-CONNECTED state with Radio Resource Control (RRC) inactive indication, locally releasing the one or more PDU sessions associated with the S-NSSAI.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates a flow chart of network slice enhancement for change in TA due to a handover during a mobility registration update (MRU) procedure, according to some implementations.

FIG. 3 illustrates a flow chart of network slice enhancement for on-demand network slices, according to some implementations.

FIG. 4 illustrates a flow chart of network slice enhancement for network slice replacement.

FIG. 5 illustrates another flow chart of network slice enhancement for network slice replacement, according to some implementations.

FIG. 6 illustrates a flow chart of network slice enhancement for session management for partial network slice, according to some implementations.

FIG. 7 illustrates another flow chart of network slice enhancement for session management for partial network slice, according to some implementations.

FIG. 8 illustrates another flow chart of network slice enhancement for releasing PDU sessions, according to some implementations.

FIG. 9 illustrates an example user equipment (UE), according to some implementations.

FIG. 10 illustrates an example access node, according to some implementations.

FIG. 11 illustrates an architecture of a system including a core network (CN), according to some implementations.

### DETAILED DESCRIPTION

This disclosure describes methods and systems for network slice enhancements. The techniques disclosed herein allow UE to enhance network slicing when using partial network slices or on-demand network slices or performing network slice replacement.

In some implementations, the network slice enhancements relate to UE behaviors for a TA change due to a handover during a mobility registration update procedure (MRU). If a new TA is still in a registration area associated with the UE in a 5GMM-CONNECTED state, the UE can continue to perform and complete the MRU procedure without interruption. If the new TA is outside of the registration area, the UE can continue to stay in the 5GMM-CONNECTED state, abort the ongoing MRU procedure, and re-initiate a new MRU procedure.

In some implementations, the network slice enhancements relate to on-demand network slices. If an RSD of a URSP rule is invalid and none of S-NSSAIs associated with the RSD are included in either an allowed NSSAI or a partially allowed NSSAI, the UE can initiate an MRU procedure to add one or more S-NSSAIs associated with the RSD to either the allowed NSSAI or the partially allowed NSSAI.

In some implementations, the network slice enhancements relate to network slice replacement. If an S-NSSAI is subject to NSSAA, this S-NSSAI can be selected as an alternative S-NSSAI only if it is one of the UE's Subscribed S-NSSAIs.

In some implementations, the network slice enhancements relate to session management for partial network slices. If the S-NSSAI is included in a partially allowed NSSAI and if the current TAI is in the list of TAs for which the S-NSSAI is rejected or the UE is outside the NS-AoS of the S-NSSAI, the UE will not initiate a UE-requested PDU session establishment procedure for the S-NSSAI. Further, if an existing PDU session is established for the S-NSSAI included in the partially allowed NSSAI and if the current TAI is changed (UE moves to a new TA) and the current TAI is in the list of TAs for which the S-NSSAI is rejected or the UE is outside the NS-AoS of the S-NSSAI, Service Management Function (SMF) and the UE can maintain the 5GSM contexts for the established PDU.

In some implementations, the network slice enhancements relate to releasing PDU sessions for temporarily available network slices. If the S-NSSAI time validity information indicates that the S-NSSAI is available, the UE can initiate a UE-requested PDU session establishment procedure to establish a PDU session associated with the S-NSSAI. If the S-NSSAI time validity information indicates that the S-NSSAI is not available and the UE is in a 5GMM-CONNECTED state, the UE can initiate a UE-requested PDU session release procedure to release any PDU session associated with the S-NSSAI. If the UE is in a 5GMM-IDLE state or in a 5GMM-CONNECTED state with RRC inactive indication, the UE can locally release any PDU session associated with the S-NSSAI.

The 3GPP Release 18 is implementing several network slice enhancements. These network slice enhancements include, e.g., network slice replacement feature, network slice location validity, network slice time validity, partially allowed/rejected slices, and network slice usage policy control.

With respect to the network slice replacement feature, the Access and Mobility Management Function (AMF) replaces a network slice in an allowed Network Slice Selection Assistance Information (NSSAI) with an alternative NSSAI when a network slice becomes unavailable or congested. Network Slice Selection Function (NSSF) or Policy Control Function (PCF) can detect that a Single Network Slice Selection Assistance Information (S-NSSAI) becomes unavailable or congested, e.g., based on Operations, Administration, and Maintenance (OAM) or Network Data Analytics Function (NWDAF) analytics output.

With respect to network slice location validity, a network slice may be available to User Equipment (UEs) only in certain cells (e.g., NS-AoS) of Tracking Areas (TAs). The operator may configure resources for the network slices in the cells of TAs where the network slices are available. In areas of the TAs where the network slice is defined to be not available to UEs, the cells are configured with zero resources. The S-NSSAI location availability information sent to the UE includes, for each applicable S-NSSAI of the configured NSSAI, location information indicating the cells of TAs in a Registration Area (RA) where the related S-NSSAI is available. The S-NSSAI location availability information defines NS-AoS where the network slice is available.

With respect to network slice time validity, a network slice may be available only for a limited period of time as the network slice may be temporarily available or decommissioned later. A network slice may be available only for a limited period of time that is known at the network in advance, e.g., by Operations, Administration, and Maintenance (OAM) or subscription. The limited time duration may be due to: (i) the network slice is only temporarily or periodically active in the deployment (e.g., the network slice serves an event for a limited period of time or (ii) a UE may be only authorized to access the network slice for a limited period of time known in advance), or the network slice is decommissioned at a known future time. This feature is enabled by S-NSSAI validity time such that the network and the UE can reduce signaling load associated with transitions in Resource Management (RM) and Slice Management (SM) states for network slice. S-NSSAI validity time defines the validity time when the network slice is available.

In some implementations, the configured NSSAI is provided by Home Public Land Mobile Network (HPLMN) and stored in UE, based on UE subscription and other operator deployment options. The requested NSSAI is included as a part of a registration request. The allowed NSSAI refers to the set of NSSAI that a UE is permitted to select and utilize within a particular network environment. The network indicates what is allowed in a registration accept message. Rejected NSSAI refers to NSSAI that a UE is not permitted to select or utilize within a particular network environment. With rejected NSSAI, no resources are provided in Public Land Mobile Network (PLMN) or registration area. Alternative NSSAI refers to an additional set of NSSAI that a UE can select and utilize within a particular network environment. Alternative NSSAI corresponds to alternative network slices provided by the network when a network slice becomes unavailable or congested. Pending NSSAI refers to NSSAI that is awaiting, authentication, approval, activation, or provisioning within a network environment. On-demand NSSAI refers to NSSAI that is dynamically requested and provisioned by UE or subscribers based on specific service requirements or preferences. UE registers with an on-demand network slice only when a Packet Data Unit (PDU) session for user data transmission is established.

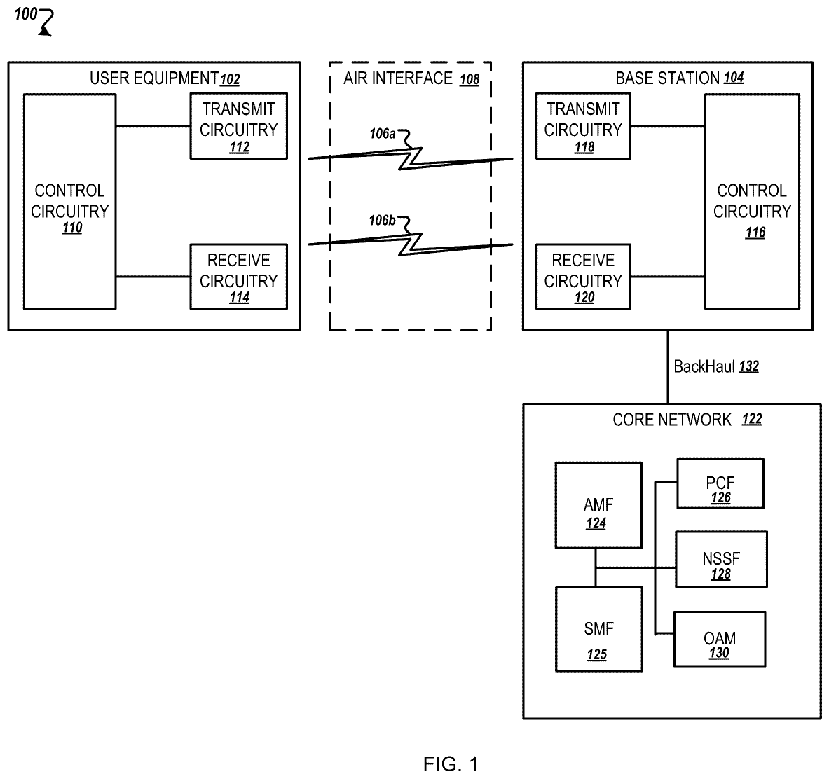

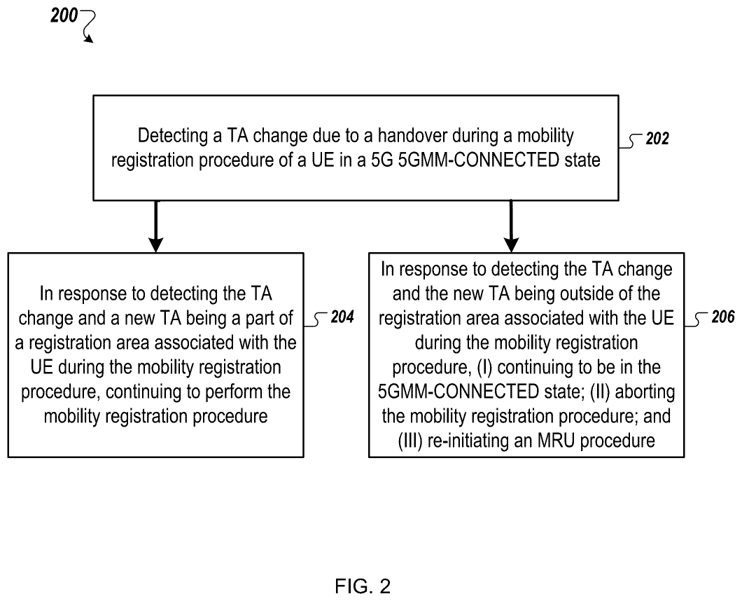

FIG. 1 illustrates an example wireless network, according to some implementations. The wireless network 100 includes a UE 102, a base station 104 connected via one or more channels 106A, 106B across an air interface 108, and a core network 122 coupled to the base station 104 via a backhaul network 132. The UE 102 and base station 104 communicate using a system that supports controls for managing the access of the UE 102 to the core network 122 via the base station 104. The UE 102 can perform network slice enhancements disclosed herein, e.g., example processes of FIGS. 2-3 and 6-8.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)-NR Dual Connectivity (EN-DC) network, or an NR-EUTRA Dual Connectivity (NE-DC) network. However, the wireless network 100 may also be a Standalone SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, base station 104 provides the UE 102 network connectivity to a broader network (not shown). This UE 102 connectivity is provided via the air interface 108 in a base station service area provided by base station 104. In some implementations, such a broader network may be a wide area network operated by a cellular network provider, or may be the Internet. Each base station service area associated with base station 104 is supported by antennas integrated with base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “EUTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels including a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, an NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a +sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

FIG. 1 further illustrates the core network 122, which is coupled to the based station 104 via the backhaul network 132. The core network 122 is responsible for managing and controlling network operations, facilitating communication between different network elements, and providing various services to end-users. The core network 122 provides an infrastructure and functionality necessary to support communication services, manage network resources, and ensure seamless connectivity for end-users. For example, the core network 122 is managing and controlling network slicing. The network slicing involves partitioning the network infrastructure into multiple virtual networks, each tailored to specific service requirements, performance objectives, and use cases. These virtual networks, known as network slices, are created to provide isolated and dedicated resources to support diverse applications, services, or customer segments.

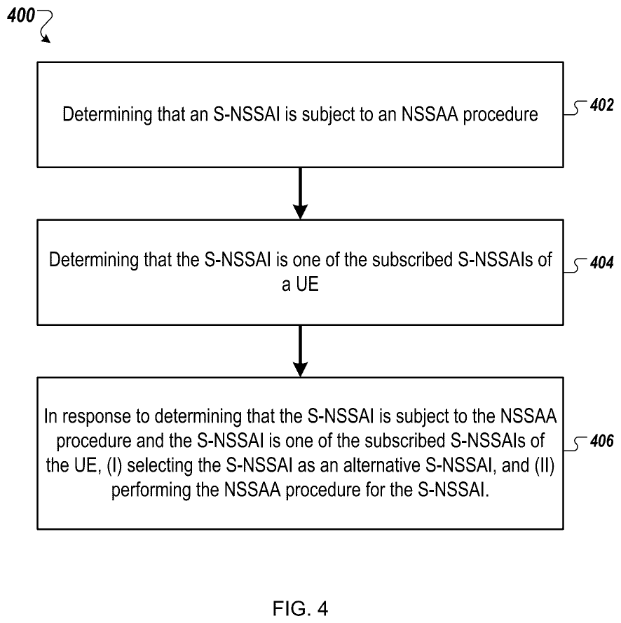

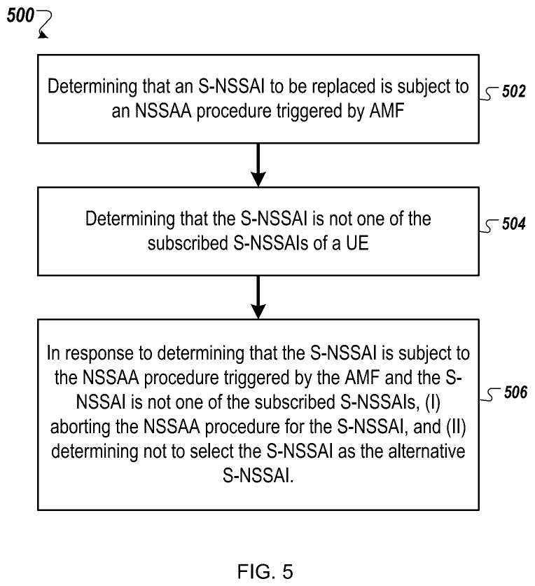

The core network 122 includes at least AMF 124, SMF 125, PCF 126, NSSF 128, OAM 130, etc. These components may be involved in managing and orchestrating network slicing. The AMF 124 is responsible for orchestrating slice selection, enforcing slice-specific policies, managing user sessions, and facilitating mobility within the 5G core network, thereby enabling operators to deliver differentiated services and meet diverse service requirements for different use cases and customer segments. The SMF 125 is responsible for managing user sessions and data flows within a network slice in the core network 122. The SMF 125 coordinates with the NSSF 128 to enable user sessions to be established, maintained, and terminated within the context of the assigned network slice, enforcing slice-specific policies, QoS parameters, and traffic routing rules. The NSSF 128 interfaces with various network elements, such as AMF 124 and SMF 125, to select and assign the appropriate network slice instance(s) for UE sessions. The PCF 126 is responsible for defining and enforcing policy rules related to network slicing in the core network 122. The PCF 126 interfaces with the NSSF 128 and other network elements to apply slice-specific policies, such as admission control, traffic steering, bandwidth allocation, and charging rules, based on service requirements and operator policies. The NSSF 128 is responsible for determining the appropriate network slice(s) to be used by a UE based on factors such as service requirements, QoS parameters, subscription profiles, and operator policies. The OAM 130 is responsible for providing the necessary tools, mechanisms, and processes to enable the efficient operation, management, and troubleshooting of network slices. The OAM 130 improves the reliability, availability, and performance of network slicing deployments by providing comprehensive management, monitoring, and control capabilities throughout the lifecycle of network slices. The core network 122, e.g., AMF 124, can perform network slice enhancements disclosed herein, e.g., example processes of FIGS. 4-5.

### UE Behavior for Change in TA Due to Handover During MRU Procedure

The existing handling of TA change in 5G Mobility Management (5GMM)-CONNECTED (5GMM-CONNECTED) state during an MRU procedure may be inefficient and may lead to unnecessary interruption. For example, a UE registered in 5G System (5GS) may have two Single Network Slice Selection Assistance Information (S-NSSAIs) in the allowed Network Slice Selection Assistance Information (NSSAI). The UE may establish PDU (Packet Data Unit) sessions for network slices corresponding to the two S-NSSAIs and have an ongoing active data session. Upper layers (higher-level protocols and functionalities that operate above the lower-level layers of the protocol stack) request the UE to connect to a new S-NSSAI, and the UE initiates an MRU procedure when the UE is in a 5GMM-CONNECTED state. Prior to completion of the MRU procedure, the UE undergoes a handover to a new Tracking Arca (TA) identified by a new Tracking Area Identity (TAI), which is still in the UE's registration area. The existing techniques request the UE to abort the ongoing MRU procedure, set the UE to an unregistered state, and re-initiate a new MRU procedure immediately. This is unnecessary and may cause disruption of ongoing data sessions.

Some implementations are provided to solve problems of the existing techniques. The UE can detect a TA change during an ongoing MRU procedure (a procedure for mobility and periodic registration update) due to a handover when the UE is in a 5GMM-CONNECTED state. In some implementations, if the new TA is a part of a registration area associated with the ongoing MRU procedure, the UE continues with the already initiated ongoing MRU procedure. In some implementations, if the new TA is not a part of the registration area associated with the ongoing MRU procedure, the UE remains in the 5GMM-CONNECTED state, aborts the ongoing MRU procedure, and re-initiates a new MRU procedure. The MRU procedure is used to periodically update the Mobility Management Entity (MME) or Access and Mobility Management Function (AMF) in the core network with the UE's current location information.

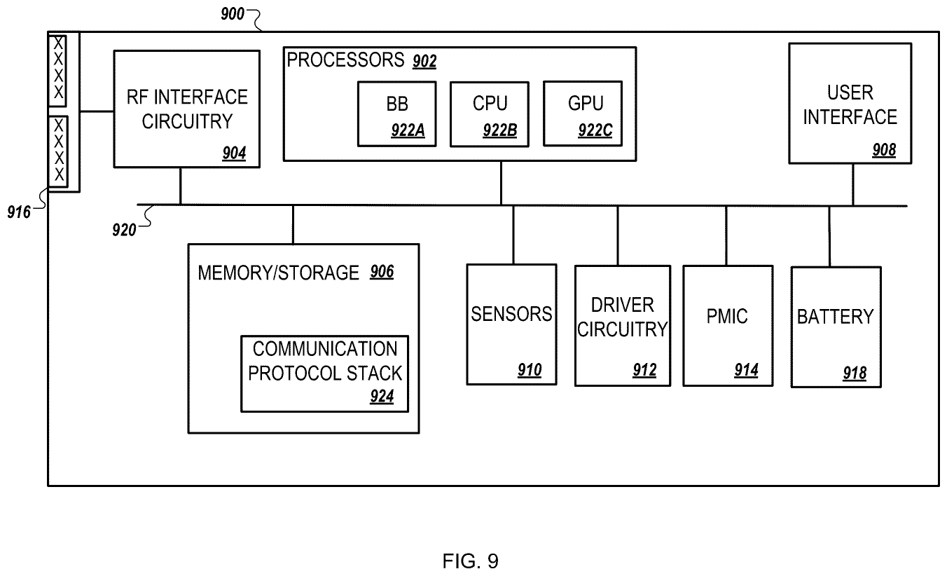

FIG. 2 illustrates a flow chart of network slice enhancement for change in TA due to a handover during an MRU procedure, according to some implementations. The process 200 is described as being performed by UE, such as UE 102 of FIG. 1 or UE 900 of FIG. 9. The example process 200 shown in FIG. 2 can be modified or reconfigured to include additional, fewer, or different steps (not shown in FIG. 2), which can be performed in the order shown or in a different order.

At 202, the UE detects a Tracking Area (TA) change due to a handover during an MRU procedure of a user equipment (UE) in a 5G Mobility Management (5GMM)-CONNECTED state.

The UE is in a 5GMM-CONNECTED state and is performing an MRU procedure for mobility and periodic registration update. Prior to completion of the MRU procedure, the UE detects a Tracking Area (TA) change (e.g., a change in the current TAI) due to a handover. Handover, also known as handoff, is an operation in cellular networks that enables the seamless transfer of an ongoing communication session from one base station (or cell) to another base station (or cell) as a UE moves within the network coverage area.

At 204, in response to detecting the TA change and a new TA being a part of a registration area associated with the UE during the MRU procedure, the UE continues to perform the MRU procedure. If the new TA is in the registration area associated with the UE, the MRU procedure is not interrupted. The UE continues to perform the MRU procedure for mobility and periodic registration update.

At 206, in response to detecting the TA change and the new TA being outside of the registration area associated with the UE during the MRU procedure, the UE (I) remains in the 5GMM-CONNECTED state; (II) aborts the MRU procedure; and (III) re-initiates a new MRU procedure. If the new TA is not in the registration area associated with the UE, the ongoing MRU procedure is interrupted. The UE aborts the ongoing MRU procedure and re-initiates a new MRU procedure while the UE continues to stay in the 5GMM-CONNECTED state.

### On-Demand Network Slices

The UE applies UE Route Selection Policy (URSP) rules to determine network slices (e.g., network slices associated with HPLMN S-NSSAIs) to be used. In some implementations, when the UE is checking the URSP rules to determine whether a PLMN supports a particular application (e.g., a gaming application), there can be more than one matching non-default URSP rule for the particular application. If the HPLMN S-NSSAI associated with the first matching URSP rule is not supported in the PLMN, it is possible that there is another matching URSP rule associated with a different S-NSSAI that is supported by the PLMN.

In some implementations, when the UE checks the URSP rules to determine whether a PLMN supports a particular application, the matching URSP rule can include a list of route selection descriptors (RSD). For example, there can be more than one RSD, and each of these RSDs can be associated with a different HPLMN S-NSSAI. For another example, if there is only one matching non-default URSP rule and only one RSD, the Network Slice Selection Policy (NSSP) of that single RSD can include multiple HPLMN S-NSSAIs, which all have the same priority.

The particular application can be mapped to multiple S-NSSAIs, and upper layers (higher-level protocol layers for processing the URSP rule for the particular application) have to consider all possible HPLMN S-NSSAIs to identify one or more S-NSSAIs that are requested in an MRU procedure.

If the UE is registered on a PLMN and a service or application (in a scenario, the service or application cannot be mapped via a URSP rule to any of network slices offered by the PLMN) is activated, then currently the RSD is considered invalid. Similarly, if the S-NSSAI(s) determined based on the matching URSP rule were included in the requested NSSAI, while the PLMN did not include S-NSSAI(s) in the allowed NSSAI or the PLMN included S-NSSAI(s) in the rejected NSSAI, then currently the RSD is considered invalid, because the associated S-NSSAI(s) are not included in the Allowed NSSAI or partially Allowed NSSAI. The invalidity of RSD prohibits on-demand network slices. Due to the invalidity of RSD, the UE cannot access on-demand network slices.

Some implementations are provided to solve problems (e.g., unavailability of on-demand network slices due to invalidity of RSD) of the existing techniques. For example, if an RSD for a S-NSSAI is not yet in the allowed NSSAI or partially Allowed NSSAI, the UE may initiate an MRU procedure to request the S-NSSAI in the RSD, attempting to request the network to add this S-NSSAI to the Allowed NSSAI or Partially allowed NSSAI, so that the RSD can be considered as valid by the UE. Once the S-NSSAI is added to the allowed NSSAI upon completion of the MRU procedure, the RSD becomes valid and the UE can evaluate the URSP rule associated with the S-NSSAI and thus access the service using the network slice identified by the S-NSSAI.

In a non-roaming scenario, if the RSD of the URSP rule is invalid and if none of the S-NSSAI(s) associated with the RSD are included in the allowed NSSAI or partially allowed NSSAI, the UE initiates an MRU procedure to add S-NSSAI(s) that are configured and associated with the RSD to the allowed NSSAI or partially allowed NSSAI.

In a roaming scenario, if the RSD of the URSP rule is invalid and if none of the S-NSSAI(s) associated with the RSD are included in the allowed NSSAI or partially allowed NSSAI mapped to HPLMN NSSAI(s), the UE initiates an MRU procedure to add S-NSSAI(s) that are configured for Visited Public Land Mobile Network (VPLMN) and mapped to HPLMN NSSAI(s) to the allowed NSSAI or partially allowed NSSAI. The UE initiates an MRU procedure only if there are no other restrictions (such as an ongoing emergency call) for the UE to initiate an MRU procedure.

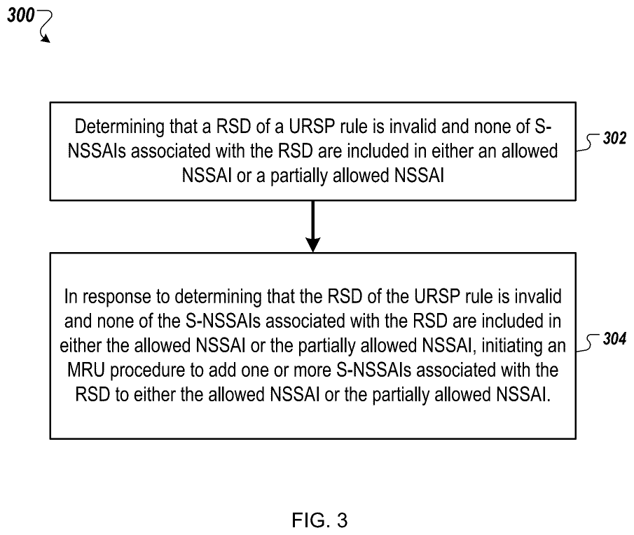

FIG. 3 illustrates a flow chart of network slice enhancement for on-demand network slices, according to some implementations. The process 300 is described as being performed by UE, such as UE 102 of FIG. 1 or UE 900 of FIG. 9. The example process 300 shown in FIG. 3 can be modified or reconfigured to include additional, fewer, or different steps (not shown in FIG. 3), which can be performed in the order shown or in a different order.

At 302, the UE determines that a route selection descriptor (RSD) of a URSP rule is invalid and none of Single Network Slice Selection Assistance Information (S-NSSAIs) associated with the RSD are included in either an allowed Network Slice Selection Assistance Information (NSSAI) or a partially allowed NSSAI.

At 304, in response to determining that the RSD of the URSP rule is invalid and none of the S-NSSAIs associated with the RSD are included in either the allowed NSSAI or the partially allowed NSSAI, the UE initiates an MRU procedure to add one or more S-NSSAIs associated with the RSD to either the allowed NSSAI or the partially allowed NSSAI. The one or more S-NSSAIs are in a configured NSSAI.

### Network Slice Replacement

The network slice replacement refers to replacing an S-NSSAI with an alternative S-NSSAI when an S-NSSAI becomes unavailable or congested. However, the network may replace an existing network slice with an alternative slice that does not meet the minimum requirements of the replaced network slice. Accordingly, the UE does not receive appropriate service as per the original SLA (an SLA corresponding to the replaced network slice) from the alternative slice, leading to suboptimal performance or release of the PDU session and application termination.

Furthermore, the network may replace an existing network slice with an alternative slice that is subject to an NSSAA procedure, and the NSSAA procedure may fail. Accordingly, the UE is unable to use the alternative slice due to failure of the NSSAA procedure, and thus, the PDU session gets released.

Some implementations are provided to solve these problems of the existing techniques. In some implementations, the alternative network slice is selected only if it can support minimum requirements for the services and any SLA supported by the replaced network slice. This implementation can solve the first problem. In some implementations, the entity (e.g., network management functions or policy control functions (PCF)) determining the alternative S-NSSAI can be different from the entity (e.g., Network Slice Selection Function (NSSF)) performing the network slice replacement.

In some implementations, if an S-NSSAI is subject to an NSSAA procedure, then this S-NSSAI can be selected as an alternative S-NSSAI only if it is one of the UE's Subscribed S-NSSAIs. This implementation can solve the second problem.

The network, e.g., AMF, can check with User Data Management (UDM) to obtain subscription information. If the alternative S-NSSAI is not one of the UE's Subscribed S-NSSAIs, the UE thus does not have NSSAA credentials for the alternative S-NSSAI, and the network determines not to select such alternative S-NSSAI subject to an NSSAA procedure. If the alternative S-NSSAI is one of the UE's subscribed S-NSSAIs, the UE has NSSAA credentials for the alternative S-NSSAI, and the operator can select such alternative S-NSSAI subject to the NSSAA procedure. The network, e.g., AMF, can perform and complete the NSSAA procedure prior to network slice replacement.

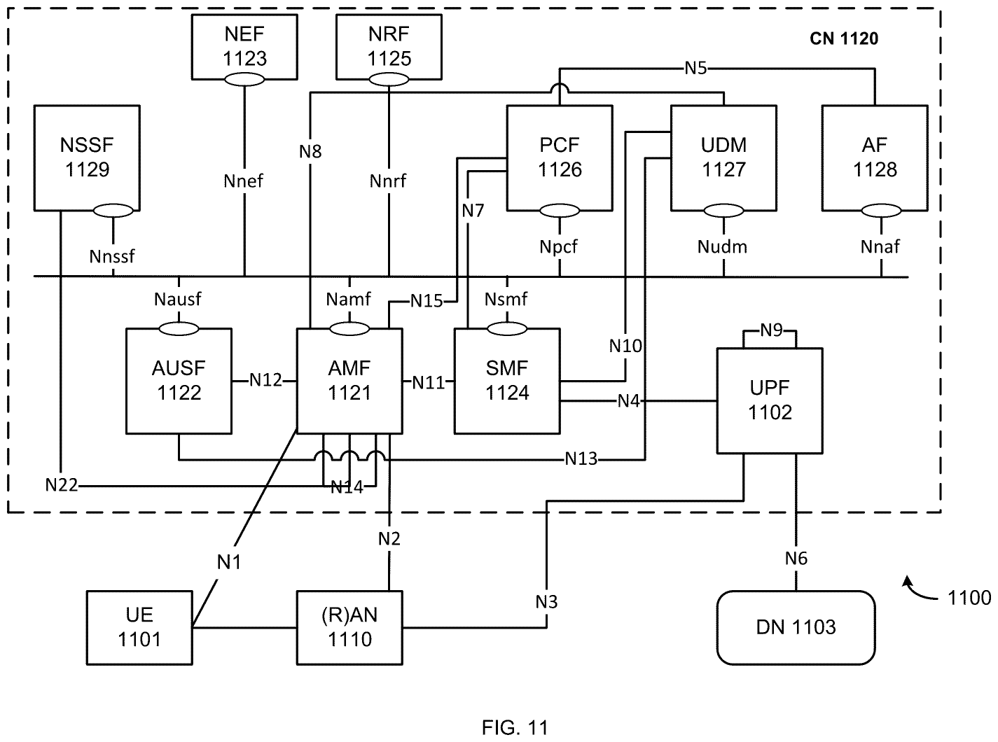

FIG. 4 illustrates a flow chart of network slice enhancement for network slice replacement, according to some implementations. The process 400 is described as being performed by 5G Core Network (5GC), e.g., core network 122 of FIG. 1 or core network 1120 of FIG. 11. For example, the process 400 can be performed by AMF in the 5GC, e.g., AMF 124 of FIG. 1 or AMF 1121 of FIG. 11. The example process 400 shown in FIG. 4 can be modified or reconfigured to include additional, fewer, or different steps (not shown in FIG. 4), which can be performed in the order shown or in a different order.

At 402, the AMF determines that an S-NSSAI is subject to an NSSAA procedure.

At 404, the AMF determines that the S-NSSAI is one of the subscribed S-NSSAIs of a UE.

At 406, in response to determining that the S-NSSAI is subject to the NSSAA procedure and the S-NSSAI is one of the subscribed S-NSSAIs of the UE, the AMF (I) selects the S-NSSAI as an alternative S-NSSAI, and (II) performs the NSSAA procedure for the S-NSSAI (the alternative S-NSSAI). The alternative S-NSSAI is one of the subscribed S-NSSAIs of the UE. A network slice associated with the alternative S-NSSAI meets minimum requirements for one or more services and Service Level Agreements (SLAs) enabled by a network slice associated with a S-NSSAI that becomes unavailable or congested.

The example process 400 is performed using Operations, Administration, and Maintenance (OAM), Policy Control Function (PCF), or Network Slice Selection Function (NSSF).

FIG. 5 illustrates another flow chart of network slice enhancement for network slice replacement, according to some implementations. The process 500 is described as being performed by 5G Core Network (5GC), such as AMF. The example process 500 shown in FIG. 5 can be modified or reconfigured to include additional, fewer, or different steps (not shown in FIG. 5), which can be performed in the order shown or in a different order.

At 502, the AMF determines that an S-NSSAI to be replaced is subject to an NSSAA procedure triggered by the AMF.

At 504, the AMF determines that the S-NSSAI is not one of the subscribed S-NSSAIs of a UE.

At 506, in response to determining that the S-NSSAI is subject to the NSSAA procedure triggered by the AMF and the S-NSSAI is not one of the subscribed S-NSSAIs, the AMF (I) aborts the NSSAA procedure for the S-NSSAI, and (II) determines not to select the S-NSSAI as the alternative S-NSSAI. If the S-NSSAI is not one of the subscribed S-NSSAIs, this S-NSSAI cannot be selected as an alternative S-NSSAI.

Session Management for Partial Network Slice when UE is Outside Network Slice AOS

If a UE moves from a TA where an S-NSSAI is available to a new TA. The UE in the new TA is outside the Area of Service (AoS) for a network slice associated with this S-NSSAI. However, the UE is still able to request user plane resources (the resources within a network that are dedicated to handling user data traffic) for an established PDU session when the UE is outside the AoS. Availability of the user plane resources when the UE is outside the AoS is a violation of the location validity of the network slice associated with this S-NSSAI in this AoS. For example, UE is in TA1 and sends the requested NSSAI with S-NSSAI(1) and S-NSSAI(2). UE receives a Registration Accept message with S-NSSAI(1) in an allowed NSSAI and S-NSSAI(2) in a partially allowed NSSAI. A registration area includes TA1 and TA2. The partially allowed NSSAI for S-NSSAI(2) only has TAI in the list of TAs where the S-NSSAI(2) is allowed. A PDU session is established for S-NSSAI(2). UE moves to TA2 and the PDU session continues to remain active. Since the PDU session remains active, the UE can still request user plane resources for the PDU session even though the UE is outside of AoS for S-NSSAI(2), which is a violation of the location validity of the network slice associated with S-NSSAI(2) in the AoS.

Partial network slice support in a registration area and NS-AoS (e.g., availability) does not match deployed Tracking Areas. An established PDU Session context is maintained by the UE and Service Management Function (SMF) when the UE is located outside the NS-AoS or the partial network slice support. However, the existing techniques do not allow the UE and the network to initiate a PDU Session modification procedure or a PDU Session release procedure for the established PDU Session.

Some implementations are provided to solve these problems of the existing techniques. If the S-NSSAI is included in a partially allowed NSSAI and if the current TAI is in the list of TAs for which the S-NSSAI is rejected or the UE is outside the NS-AoS of the S-NSSAI, the UE determines not to initiate a UE-requested PDU session establishment procedure for the S-NSSAI. Since the UE does not initiate the PDU session establishment procedure, the UE is unable to request user plane resources when the UE is outside the NS-AoS, which can maintain the integrity of location validity in that AoS. This implementation solves the first problem.

In some implementations, if an existing PDU session is established for the S-NSSAI included in the partially allowed NSSAI and if the current TAI is changed (UE moves to a new TA) and the current TAI is in the list of TAs for which the S-NSSAI is rejected or the UE is outside the NS-AoS of the S-NSSAI, the Session Management Function (SMF) and the UE can maintain the 5G system Session Management (5GSM) contexts for the established PDU. In the scenarios where an established PDU session is associated with an S-NSSAI included in the partially allowed NSSAI or if NS-AoS for the S-NSSAI applies, at any UE location in the RA (e.g., even when the UE is outside the network slice area of support or availability), the UE or the SMF can be allowed to initiate either a PDU session release procedure or a PDU session modification procedure, e.g., for modifying the Packet Switched (PS) data off status. This implementation solves the second problem.

In some implementations, mobility restrictions for a PDU session establishment procedure are also applicable to a PDU session modification procedure for a partial network slice. No mobility restrictions apply to a PDU session release procedure.

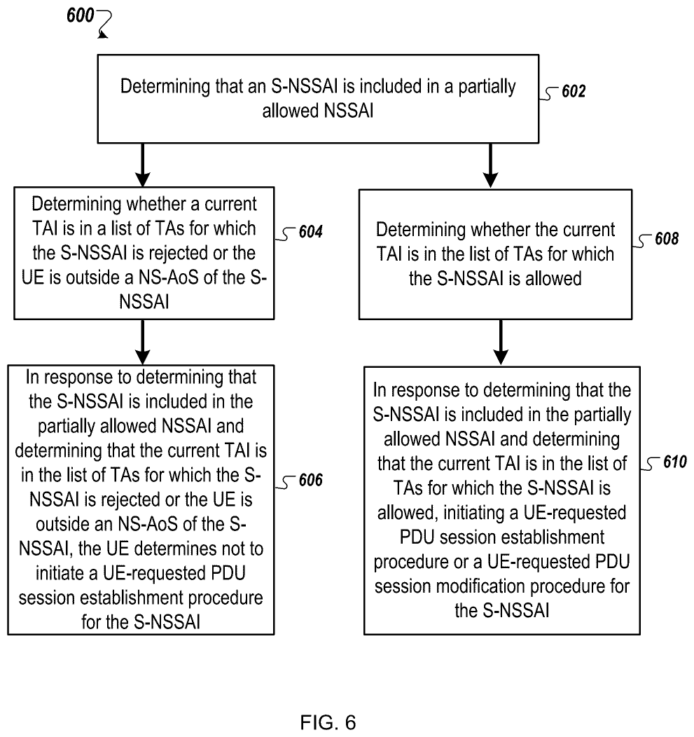

FIG. 6 illustrates a flow chart of network slice enhancement for session management for partial network slice, according to some implementations. The process 600 is described as being performed by UE, such as UE 102 of FIG. 1 or UE 900 of FIG. 9. The example process 600 shown in FIG. 6 can be modified or reconfigured to include additional, fewer, or different steps (not shown in FIG. 6), which can be performed in the order shown or in a different order.

At 602, the UE determines that an S-NSSAI is included in a partially allowed NSSAI.

At 604, the UE determines whether a current TAI is in a list of TAs for which the S-NSSAI is rejected or the UE is outside a Network Slice-Area of Service (NS-AoS) of the S-NSSAI. Upon the change of TAI, the network slice associated with the S-NSSAI is rejected in the new TAI. Thus, the new TAI is in a list of TAs where the network slice is rejected.

At 606, in response to determining that the S-NSSAI is included in the partially allowed NSSAI and determining that the current TAI is in the list of TAs for which the S-NSSAI is rejected or the UE is outside an NS-AoS of the S-NSSAI, the UE determines not to initiate a UE-requested Packet Data Unit (PDU) session establishment procedure for the S-NSSAI.

At 608, the UE determines whether the current TAI is in the list of TAs for which the S-NSSAI is allowed.

At 610, in response to determining that the S-NSSAI is included in the partially allowed NSSAI and determining that the current TAI is in the list of TAs for which the S-NSSAI is allowed, the UE initiates a UE-requested PDU session establishment procedure or a UE-requested PDU session modification procedure for the S-NSSAI.

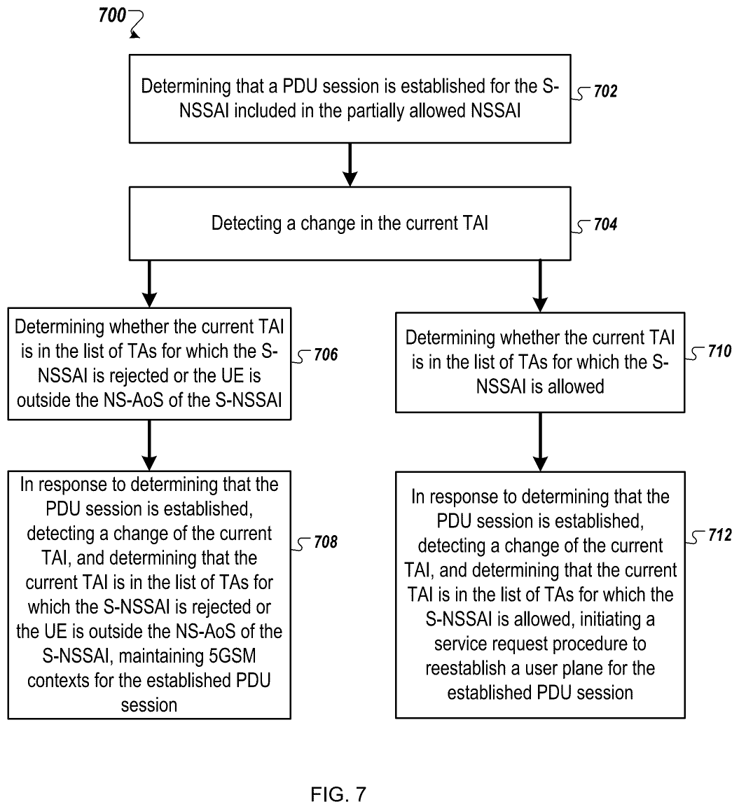

FIG. 7 illustrates another flow chart of network slice enhancement for session management for partial network slice, according to some implementations. The process 700 is described as being performed by UE, such as UE 102 of FIG. 1 or UE 900 of FIG. 9. The example process 700 shown in FIG. 7 can be modified or reconfigured to include additional, fewer, or different steps (not shown in FIG. 7), which can be performed in the order shown or in a different order.

At 702, the UE determines that a PDU session is established for the S-NSSAI included in the partially allowed NSSAI.

At 704, the UE detects a change in the current TAI. The UE moves to a new TA.

At 706, the UE determines whether the current TAI is in the list of TAs for which the S-NSSAI is rejected or the UE is outside the NS-AoS of the S-NSSAI.

At 708, in response to determining that the PDU session is established, detecting a change of the current TAI, and determining that the current TAI is in the list of TAs for which the S-NSSAI is rejected or the UE is outside the NS-AoS of the S-NSSAI, the UE maintains 5GSM contexts for the established PDU session.

At 710, the UE determines whether the current TAI is in the list of TAs for which the S-NSSAI is allowed.

At 712, in response to determining that the PDU session is established, detecting a change of the current TAI, and determining that the current TAI is in the list of TAs for which the S-NSSAI is allowed, the UE initiates a service request procedure to reestablish a user plane for the established PDU session.

In some implementations, the UE is allowed to initiate a PDU session release procedure for an active PDU session associated with an S-NSSAI in the partially allowed NSSAI even if the current TAI of the registration area is not in the list of TAs for which the S-NSSAI is allowed.

In some implementations, for an established PDU Session associated with an S-NSSAI included in the Partially Allowed NSSAI, even when the UE is in a TA where the S-NSSAI is not supported, the UE and the SMF can initiate a PDU Session release procedure or PDU Session modification procedure.

### Releasing PDU Sessions for Temporarily Available Network Slices

A network slice can be available temporarily. For a UE supporting S-NSSAI time validity information, there is redundancy over the air signaling for a PDU session release procedure. Both the UE and the AMF remove temporary network slices from the allowed/partially allowed NSSAI, and the associated PDU sessions are also locally released for a UE in a 5GMM-Idle state. Both UE and AMF attempting to release a PDU session can lead to procedure collision and redundancy, because the PDU session may be already released locally by one/both of the nodes (UE/Network) due to the temporary slice being removed from allowed/partially allowed NSSAI based on a validity timer. A validity timer is a timer mechanism used to manage the validity or expiration period of certain parameters, information, or states within a network protocol. The validity timer enables the information to remain relevant and up-to-date, and it may trigger actions when the timer expires. Both the UE and network can release a PDU session associated with a network slice when the network slice becomes unavailable due to time validity, which causes signaling collision and additional signaling overhead as well.

Some implementations are provided to solve problems of the existing techniques. If the S-NSSAI time validity information indicates that the S-NSSAI is available, the UE can initiate a UE-requested PDU session establishment procedure to establish a PDU session associated with the S-NSSAI. If the S-NSSAI time validity information indicates that the S-NSSAI is not available and the UE is in a 5GMM-CONNECTED state, the UE initiates a UE-requested PDU session release procedure to release any PDU session associated with the S-NSSAI. If the UE is in a 5GMM-IDLE state or in a 5GMM-CONNECTED state with Radio Resource Control (RRC) inactive indication, the UE locally releases any PDU session associated with the S-NSSAI. The UE is allowed to locally release a PDU session without sending any message over the air signaling to the network, which reduces signaling overhead.

In other implementations, when the S-NSSAI time validity information in the AMF indicates that the S-NSSAI is not available, independent of whether the UE is in a 5GMM-CONNECTED mode, a 5GMM-CONNECTED mode with RRC inactive indication or in a 5GMM-IDLE mode, the AMF can request the SMF to release any PDU session associated with the S-NSSAI. The AMF notifies the UE of the release by sending a PDU Session Release message over the air interface (e.g., air interface 108 of FIG. 1), so that the UE will not perform a PDU session release procedure redundantly, thereby avoiding signaling collision.

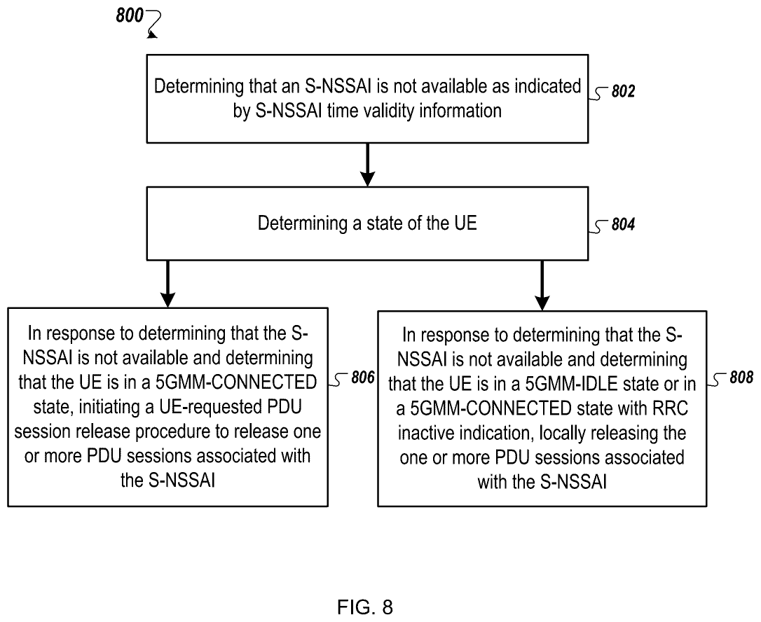

FIG. 8 illustrates another flow chart of network slice enhancement for releasing PDU sessions, according to some implementations. The process 800 is described as being performed by UE, such as UE 102 of FIG. 1 or UE 900 of FIG. 9. The example process 800 shown in FIG. 8 can be modified or reconfigured to include additional, fewer, or different steps (not shown in FIG. 8), which can be performed in the order shown or in a different order.

At 802, the UE determines that an S-NSSAI is not available as indicated by S-NSSAI time validity information.

At 804, the UE determines a state of the UE.

At 806, in response to determining that the S-NSSAI is not available and determining that the UE is in a 5G Mobility Management (5GMM)-CONNECTED state, the UE initiates a UE-requested PDU session release procedure to release one or more PDU sessions associated with the S-NSSAI.

At 808, in response to determining that the S-NSSAI is not available and determining that the UE is in a 5GMM-IDLE state or in a 5GMM-CONNECTED state with RRC inactive indication, the UE locally releases the one or more PDU sessions associated with the S-NSSAI.

FIG. 9 is a block diagram of an example UE, according to some implementations. The UE 900 may be similar to and substantially interchangeable with UE 102 of FIG. 1.

The UE 900 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smartwatch), relaxed-IoT devices.

The UE 900 may include processors 902, RF interface circuitry 904, memory/storage 906, user interface 908, sensors 910, driver circuitry 912, power management integrated circuit (PMIC) 914, antenna structure 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein, e.g., example processes of FIGS. 2-3 and 6-8.

In some implementations, the baseband processor circuitry 922A may access a communication protocol stack 924 in the memory/storage 906 to communicate over a 3GPP-compatible network. In general, the baseband processor circuitry 922A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based on cyclic prefix OFDM “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 includes any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random-access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 904 may include transceiver circuitry and a radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 916.

In various implementations, the RF interface circuitry 904 may be configured to transmit/receive signals in a manner compatible with NR access technologies.

The antenna 916 may include antenna elements to convert electrical signals into radio waves to travel through the air and convert received radio waves into electrical signals. The antenna elements may be arranged into one or more antenna panels. The antenna 916 may have antenna panels that are omnidirectional, directional, or a combination thereof to enable beamforming and multiple input, multiple output communications. The antenna 916 may include microstrip antennas, printed antennas fabricated on the surface of one or more printed circuit boards, patch antennas, phased array antennas, etc. The antenna 916 may have one or more panels designed for specific frequency bands including bands in FRI or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensor circuitry 910 and control and allow access to sensor circuitry 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900 including DRX as discussed herein. A battery 918 may power the UE 900, although in some examples the UE 900 may be mounted or deployed in a fixed location, and may have a power supply coupled to an electrical grid. The battery 918 may be a lithium-ion battery, a metal-air battery, such as a zinc-air battery, an aluminum-air battery, a lithium-air battery, and the like. In some implementations, such as in vehicle-based applications, the battery 918 may be a typical lead-acid automotive battery.

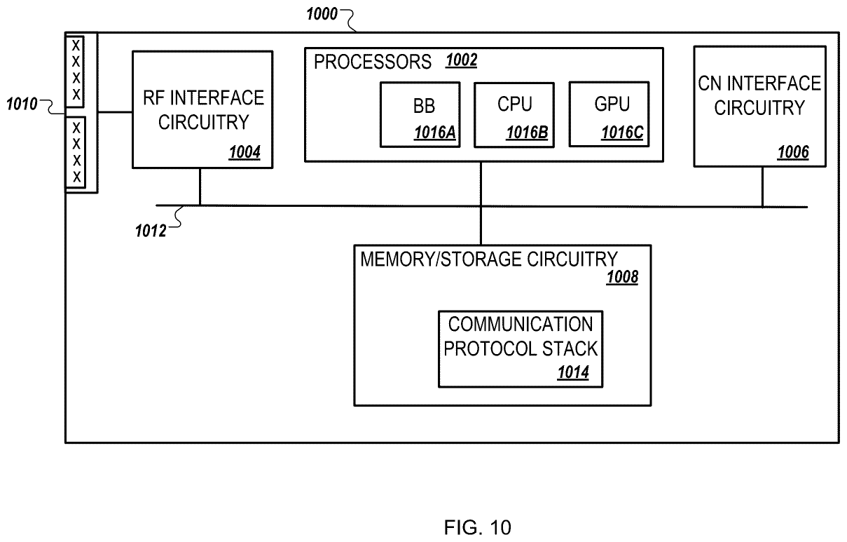

FIG. 10 is a block diagram of an example access node, according to some implementations. FIG. 10 illustrates an access node 1000 (e.g., a base station or gNB), in accordance with some implementations. The access node 1000 may be similar to and substantially interchangeable with the base station 104 of FIG. 1. The access node 1000 may include processors 1002, RF interface circuitry 1004, core network (CN) interface circuitry 1006, memory/storage circuitry 1008, and antenna structure 1010.

The components of the access node 1000 may be coupled with various other components over one or more interconnects 1012. The processors 1002, RF interface circuitry 1004, memory/storage circuitry 1008 (including communication protocol stack 1014), antenna structure 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, cNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells, or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

FIG. 11 illustrates an architecture of a system 1100 including a core network (CN) 1120 in accordance with various embodiments. The system 1100 is shown to include a 5GC 1120, which may be the same or similar to core network 122 of FIG. 1; a UE 1101, which may be the same or similar to the UE 102 of FIG. 1 or the UE 900 of FIG. 9; a (R)AN 1110, which includes a base station or an access node 104 of FIG. 1 or a base station or an access node of FIG. 10; and a DN 1103, which may be, for example, operator services, Internet access, or 3rd party services. The 5GC 1120 may include an AUSF 1122, an AMF 1121, an SMF 1124, an NEF 1123, a PCF 1126, an NRF 1125, a UDM 1127, an AF 1128, a UPF 1102, and a NSSF 1129. In some embodiments, the AMF 1121 may be the same or similar to AMF 124 of FIG. 1. The SMF 1124 may be the same or similar to SMF 125 of FIG. 1. The PCF 1126 may be the same or similar to PCF 126 of FIG. 1. The NSSF 1129 may be the same or similar to NSSF 128 of FIG. 1.

The UPF 1102 may act as an anchor point for intra-RAT and inter-RAT mobility, an external PDU session point of interconnect to DN 1103, and a branching point to support multi-homed PDU session. The UPF 1102 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 1102 may include an uplink classifier to support routing traffic flows to a data network. The DN 1103 may represent various network operator services, Internet access, or third-party services. DN 1103 may include, or be similar to, application server XQ30 discussed previously. The UPF 1102 may interact with the SMF 1124 via an N4 reference point between the SMF 1124 and the UPF 1102.

The AUSF 1122 may store data for authentication of UE 1101 and handle authentication-related functionality. The AUSF 1122 may facilitate a common authentication framework for various access types. The AUSF 1122 may communicate with the AMF 1121 via an N12 reference point between the AMF 1121 and the AUSF 1122, and may communicate with the UDM 1127 via an N13 reference point between the UDM 1127 and the AUSF 1122. Additionally, the AUSF 1122 may exhibit a Nausf service-based interface.

The AMF 1121 may be responsible for registration management (e.g., for registering UE 1101, etc.), connection management, reachability management, mobility management, lawful interception of AMF-related events, and access authentication and authorization. The AMF 1121 may be a termination point for the N11 reference point between the AMF 1121 and the SMF 1124. The AMF 1121 may provide transport for SM messages between the UE 1101 and the SMF 1124, and act as a transparent proxy for routing SM messages. AMF 1121 may also provide transport for SMS messages between UE 1101 and an SMSF (not shown by FIG. 11). AMF 1121 may act as SEAF, which may include interaction with the AUSF 1122 and the UE 1101, receipt of an intermediate key that was established as a result of the UE 1101 authentication process. Where USIM-based authentication is used, the AMF 1121 may retrieve the security material from the AUSF 1122. AMF 1121 may also include a SCM function, which receives a key from the SEA that it uses to derive access-network specific keys. Furthermore, AMF 1121 may be a termination point of a RAN CP interface, which may include or be an N2 reference point between the (R)AN 1110 and the AMF 1121, and the AMF 1121 may be a termination point of NAS (N1) signaling and perform NAS ciphering and integrity protection.

AMF 1121 may also support NAS signaling with a UE 1101 over an N3 IWF interface. The N3IWF may be used to provide access to untrusted entities. N3IWF may be a termination point for the N2 interface between the (R)AN 1110 and the AMF 1121 for the control plane, and may be a termination point for the N3 reference point between the (R)AN 1110 and the UPF 1102 for the user plane. As such, the AMF 1121 may handle N2 signaling from the SMF 1124 and the AMF 1121 for PDU sessions and QoS, encapsulate/de-encapsulate packets for IPSec and N3 tunneling, mark N3 user-plane packets in the uplink, and enforce QoS corresponding to N3 packet marking taking into account QoS requirements associated with such marking received over N2. N3IWF may also relay uplink and downlink control-plane NAS signaling between the UE 1101 and AMF 1121 via an N1 reference point between the UE 1101 and the AMF 1121, and relay uplink and downlink user-plane packets between the UE 1101 and UPF 1102. The N3IWF also provides mechanisms for IPsec tunnel establishment with the UE 1101. The AMF 1121 may exhibit a Namf service-based interface, and may be a termination point for an N14 reference point between two AMFs 1121 and an N17 reference point between the AMF 1121 and a 5G-EIR (not shown by FIG. 11).

The UE 1101 may need to register with the AMF 1121 in order to receive network services. RM is used to register or deregister the UE 1101 with the network (e.g., AMF 1121), and establish a UE context in the network (e.g., AMF 1121). The UE 1101 may operate in an RM-REGISTERED state or an RM-DEREGISTERED state. In the RM DEREGISTERED state, the UE 1101 is not registered with the network, and the UE context in AMF 1121 holds no valid location or routing information for the UE 1101 such that the UE 1101 is not reachable by the AMF 1221. In the RM REGISTERED state, the UE 1101 is registered with the network, and the UE context in AMF 1121 may hold a valid location or routing information for the UE 1101 such that the UE 1101 is reachable by the AMF 1121. In the RM-REGISTERED state, the UE 1101 may perform mobility Registration Update procedures, perform periodic Registration Update procedures triggered by the expiration of the periodic update timer (e.g., to notify the network that the UE 1101 is still active), and perform a Registration Update procedure to update UE capability information or to re-negotiate protocol parameters with the network, among others.

The AMF 1121 may store one or more RM contexts for the UE 1101, where each RM context is associated with a specific access to the network. The RM context may be a data structure, database object, etc. That indicates or stores, inter alia, a registration state per access type and the periodic update timer. The AMF 1121 may also store a 5GC MM context that may be the same or similar to the (E) MM context discussed previously. In various embodiments, the AMF 1121 may store a CE mode B Restriction parameter of the UE 1101 in an associated MM context or RM context. The AMF 1121 may also derive the value, when needed, from the UE's usage setting parameter already stored in the UE context (and/or MM/RM context).

CM may be used to establish and release a signaling connection between the UE 1101 and the AMF 1121 over the N1 interface. The signaling connection is used to enable NAS signaling exchange between the UE 1101 and the CN 1120, and includes both the signaling connection between the UE and the AN (e.g., RRC connection or UE-N3IWF connection for non-3GPP access) and the N2 connection for the UE 1101 between the AN (e.g., RAN 1110) and the AMF 1121. The UE 1101 may operate in one of two CM states, CM-IDLE mode or CM-CONNECTED mode. When the UE 1101 is operating in the CM-IDLE state/mode, the UE 1101 may have no NAS signaling connection established with the AMF 1121 over the N1 interface, and there may be (R)AN 1110 signaling connection (e.g., N2 and/or N3 connections) for the UE 1101. When the UE 1101 is operating in the CM-CONNECTED state/mode, the UE 1101 may have an established NAS signaling connection with the AMF 1121 over the N1 interface, and there may be a (R)AN 1110 signaling connection (e.g., N2 and/or N3 connections) for the UE 1101. Establishment of an N2 connection between the (R)AN 1110 and the AMF 1121 may cause the UE 1101 to transition from CM-IDLE mode to CM-CONNECTED mode, and the UE 1101 may transition from the CM-CONNECTED mode to the CM-IDLE mode when N2 signaling between the (R)AN 1110 and the AMF 1121 is released.

The SMF 1124 may be responsible for SM (e.g., session establishment, modification and release, including tunnel maintenance between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM may refer to the management of a PDU session, and a PDU session or “session” may refer to a PDU connectivity service that provides or enables the exchange of PDUs between a UE 1101 and a data network (DN) 1103 identified by a Data Network Name (DNN). PDU sessions may be established upon UE 1101 request, modified upon UE 1101 and 5GC 1120 request, and released upon UE 1101 and 5GC 1120 request using NAS SM signaling exchanged over the N1 reference point between the UE 1101 and the SMF 1124. Upon request from an application server, the 5GC 1120 may trigger a specific application in the UE 1101. In response to receipt of the trigger message, the UE 1101 may pass the trigger message (or relevant parts/information of the trigger message) to one or more identified applications in the UE 1101. The identified application(s) in the UE 1101 may establish a PDU session to a specific DNN. The SMF 1124 may check whether the UE 1101 requests are compliant with user subscription information associated with the UE 1101. In this regard, the SMF 1124 may retrieve and/or request to receive update notifications on SMF 1124 level subscription data from the UDM 1127.

The SMF 1124 may include the following roaming functionality: handling local enforcement to apply QOS SLAs (VPLMN); charging data collection and charging interface (VPLMN); lawful intercept (in VPLMN for SM events and interface to LI system); and support for interaction with external DN for transport of signaling for PDU session authorization/authentication by external DN. An N16 reference point between two SMFs 1124 may be included in the system 1100, which may be between another SMF 1124 in a visited network and the SMF 1124 in the home network in roaming scenarios. Additionally, the SMF 1124 may exhibit the Nsmf service-based interface.

The NEF 1123 may provide means for securely exposing the services and capabilities provided by 3GPP network functions for third party, internal exposure/re-exposure, Application Functions (e.g., AF 1128), edge computing or fog computing systems, etc. In such embodiments, the NEF 1123 may authenticate, authorize, and/or throttle the AFs. NEF 1123 may also translate information exchanged with the AF 1128 and information exchanged with internal network functions. For example, the NEF 1123 may translate between an AF-Service-Identifier and an internal 5GC information. NEF 1123 may also receive information from other network functions (NFs) based on the exposed capabilities of other network functions. This information may be stored at the NEF 1123 as structured data, or at a data storage NF using standardized interfaces. The stored information can then be re-exposed by the NEF 1123 to other NFs and AFs, and/or used for other purposes such as analytics. Additionally, the NEF 1123 may exhibit an Nnef service-based interface.

The NRF 1125 may support service discovery functions, receive NF discovery requests from NF instances, and provide information on the discovered NF instances to the NF instances. NRF 1125 also maintains information on available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1125 may exhibit the Nnrf service-based interface.

The PCF 1126 may provide policy rules to control plane function(s) to enforce them, and may also support a unified policy framework to govern network behavior. The PCF 1126 may also implement an FE to access subscription information relevant to policy decisions in a UDR of the UDM 1127. The PCF 1126 may communicate with the AMF 1121 via an N15 reference point between the PCF 1126 and the AMF 1121, which may include a PCF 1126 in a visited network and the AMF 1121 in case of roaming scenarios. The PCF 1126 may communicate with the AF 1128 via an N5 reference point between the PCF 1126 and the AF 1128, and with the SMF 1124 via an N7 reference point between the PCF 1126 and the SMF 1124. The system 1100 and/or CN 1120 may also include an N24 reference point between the PCF 1226 (in the home network) and a PCF 1126 in a visited network. Additionally, the PCF 1126 may exhibit an Npcf service-based interface.

The UDM 1127 may handle subscription-related information to support the network entities' handling of communication sessions, and may store subscription data of UE 1101. For example, subscription data may be communicated between the UDM 1127 and the AMF 1121 via an N8 reference point between the UDM 1127 and the AMF. The UDM 1127 may include two parts, an application FE and a UDR (the FE and UDR are not shown in FIG. 11). The UDR may store subscription data and policy data for the UDM 1127 and the PCF 1126, and/or structured data for exposure and application data (including PFDs for application detection, application request information for multiple UEs 1101) for the NEF 1123. The Nudr service-based interface may be exhibited by the UDR to allow the UDM 1127, PCF 1126, and NEF 1123 to access a particular set of the stored data, as well as to read, update (e.g., add, modify), delete, and subscribe to notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. The UDR may interact with the SMF 1124 via an N10 reference point between the UDM 1127 and the SMF 1124. UDM 1127 may also support SMS management, wherein an SMS-FE implements a similar application logic as discussed previously. Additionally, the UDM 1127 may exhibit the Nudm service-based interface.

The AF 1128 may provide application influence on traffic routing, provide access to the NCE, and interact with the policy framework for policy control. The NCE may be a mechanism that allows the 5GC 1120 and AF 1128 to provide information to each other via NEF 1123, which may be used for edge computing implementations. In such implementations, the network operator and third-party services may be hosted close to the UE 1101 access point of attachment to achieve an efficient service delivery through the reduced end-to-end latency and load on the transport network. For edge computing implementations, the 5GC may select a UPF 1102 close to the UE 1101 and execute traffic steering from the UPF 1102 to DN 1103 via the N6 interface. This may be based on the UE subscription data, UE location, and information provided by the AF 1128. In this way, the AF 1128 may influence UPF (re) selection and traffic routing. Based on operator deployment, when AF 1128 is considered to be a trusted entity, the network operator may permit AF 1128 to interact directly with relevant NFs. Additionally, the AF 1128 may exhibit a Naf service-based interface.

The NSSF 1129 may select a set of network slice instances serving the UE 1101. The NSSF 1129 may also determine allowed NSSAI and the mapping to the subscribed S-NSSAIs, if needed. The NSSF 1129 may also determine the AMF set to be used to serve the UE 1101, or a list of candidate AMF(s) 1121 based on a suitable configuration and possibly by querying the NRF 1125. The selection of a set of network slice instances for the UE 1101 may be triggered by the AMF 1121 with which the UE 1101 is registered by interacting with the NSSF 1129, which may lead to a change of AMF 1121. The NSSF 1129 may interact with the AMF 1121 via an N22 reference point between AMF 1121 and NSSF 1129, and may communicate with another NSSF 1129 in a visited network via an N31 reference point (not shown by FIG. 11). Additionally, the NSSF 1129 may exhibit an Nnssf service-based interface.

As discussed previously, the CN 1120 may include an SMSF, which may be responsible for SMS subscription checking and verification, and relaying SM messages to/from the UE 1101 to/from other entities, such as an SMS-GMSC/IWMSC/SMS-router. The SMS may also interact with AMF 1121 and UDM 1127 for a notification procedure that the UE 1101 is available for SMS transfer (e.g., set a UE not reachable flag and notify UDM 1127 when UE 1101 is available for SMS).

The CN 1120 may also include other elements that are not shown by FIG. 11, such as a Data Storage system/architecture, a 5G-EIR, a SEPP, and the like. The Data Storage system may include an SDSF, a UDSF, and/or the like. Any NF may store and retrieve unstructured data into/from the UDSF (e.g., UE contexts), via the N18 reference point between any NF and the UDSF (not shown by FIG. 11). Individual NFs may share a UDSF for storing their respective unstructured data or individual NFs may each have their own UDSF located at or near the individual NFs. Additionally, the UDSF may exhibit a Nudsf service-based interface (not shown by FIG. 11). The 5G-EIR may be an NF that checks the status of PEI for determining whether particular equipment/entities are blacklisted from the network, and the SEPP may be a non-transparent proxy that performs topology hiding, message filtering, and policing on inter-PLMN control plane interfaces.

Additionally, there may be many more reference points and/or service-based interfaces between the NF services in the NFs; however, these interfaces and reference points have been omitted from FIG. 11 for clarity. In one example, the CN 1120 may include an Nx interface, which is an inter-CN interface between the MME and the AMF 1121 in order to enable interworking between CN 1120 and another CN. Other example interfaces/reference points may include an N5g-EIR service-based interface exhibited by a 5G-EIR, an N27 reference point between the NRF in the visited network and the NRF in the home network, and an N31 reference point between the NSSF in the visited network and the NSSF in the home network.

Various components may be described in the description as performing a task or tasks for convenience. Such descriptions should be interpreted as including the phrase “configured to.” Reciting a component that is configured to perform one or more tasks is expressly intended not to invoke 35 USC § 112 (f) interpretation for that component.

For one or more implementations, at least one of the components set forth in one or more of the preceding figures may be configured to perform one or more operations, techniques, processes, or methods as set forth in the example section below.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As described above, one aspect of the present technology may relate to the gathering and use of data available from specific and legitimate sources to allow for interaction with a second device for a data transfer. The present disclosure contemplates that, in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used to provide for secure data transfers occurring between a first device and a second device. The personal information data may further be utilized to identify an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and casily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA), whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers the use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. A method, comprising:
determining that a first Single Network Slice Selection Assistance Information (S-NSSAI) is subject to a first Network Slice Specific Authentication and Authorization (NSSAA) procedure;
determining that the first S-NSSAI is one of subscribed S-NSSAIs of a user equipment (UE);
in response to determining that the first S-NSSAI is subject to the first NSSAA procedure and the first S-NSSAI is one of the subscribed S-NSSAIs of the UE,
selecting the first S-NSSAI as an alternative S-NSSAI; and
performing the first NSSAA procedure for the alternative S-NSSAI.

2. The method of claim 1, further comprising:
performing a network slice replacement after performing the first NSSAA procedure for the alternative S-NSSAI.

3. The method of claim 1, further comprising:
determining that a second S-NSSAI is subject to a second NSSAA procedure triggered by an Access and Mobility Management Function (AMF);
determining that the second S-NSSAI is not one of the subscribed S-NSSAIs of the UE;
in response to determining that the second S-NSSAI is subject to the second NSSAA procedure triggered by the AMF and the second S-NSSAI is not one of the subscribed S-NSSAIs;
aborting the second NSSAA procedure for the second S-NSSAI; and
determining not to select the second S-NSSAI as the alternative S-NSSAI.

4. The method of claim 1, wherein a network slice associated with the alternative S-NSSAI meets minimum requirements for one or more services and Service Level Agreements (SLAs) enabled by a network slice associated with a S-NSSAI to be replaced.

5. The method of claim 1, wherein the method is performed using Operations, Administration, and Maintenance (OAM), Policy Control Function (PCF), or Network Slice Selection Function (NSSF).

6. A method, comprising:
determining that a Single Network Slice Selection Assistance Information (S-NSSAI) is included in a partially allowed Network Slice Selection Assistance Information (NSSAI);
determining whether a current Tracking Area Identity (TAI) is in a list of Tracking Areas (TAs) for which the S-NSSAI is allowed; and
in response to determining that the S-NSSAI is included in the partially allowed NSSAI and determining that the current TAI is not in the list of TAs for which the S-NSSAI is allowed,
determining not to initiate a UE-requested Packet Data Unit (PDU) session establishment procedure for the S-NSSAI.

7. The method of claim 6, further comprising:
determining that the current TAI is in the list of TAs for which the S-NSSAI is allowed; and
in response to determining that the S-NSSAI is included in the partially allowed NSSAI and determining that the current TAI is in the list of TAs for which the S-NSSAI is allowed,
initiating the UE-requested PDU session establishment procedure or a UE-requested PDU session modification procedure for the S-NSSAI.

8. The method of claim 6, further comprising:
determining that a PDU session is established for the S-NSSAI included in the partially allowed NSSAI;
determining that the current TAI is not in the list of TAs for which the S-NSSAI is allowed; and
in response to determining that the PDU session is established and determining that the current TAI is not in the list of TAs for which the S-NSSAI is allowed,
maintaining 5G system Session Management (5GSM) contexts for the established PDU session.

9. The method of claim 6, further comprising:
determining that a PDU session is established for the S-NSSAI in the partially allowed NSSAI;
detecting a change in the current TAI;
determining that the current TAI is in the list of TAs for which the S-NSSAI is allowed; and
in response to determining that the PDU session is established for the S-NSSAI included in the partially allowed NSSAI and determining that the current TAI is in the list of TAs for which the S-NSSAI is allowed,
initiating a service request procedure to reestablish user plane resources for the established PDU session.

10. A method, comprising:
determining that a Packet Data Unit (PDU) session is established for a Single Network Slice Selection Assistance Information (S-NSSAI) included in a partially allowed Network Slice Selection Assistance Information (NSSAI);
determining that a User Equipment (UE) is in a Tracking Area (TA) where the S-NSSAI is not supported; and
initiating a PDU session release procedure or a PDU session modification procedure.

11. A system comprising one or more computers and one or more storage devices, on which are stored instructions that are operable, when executed by the one or more computers, to cause the one or more computers to perform the method of claim 1.

12. A system comprising one or more computers and one or more storage devices, on which are stored instructions that are operable, when executed by the one or more computers, to cause the one or more computers to perform the method of claim 6.

13. A system comprising one or more computers and one or more storage devices, on which are stored instructions that are operable, when executed by the one or more computers, to cause the one or more computers to perform the method of claim 10.

14. A non-transitory computer storage medium encoded with instructions that, when executed by one or more computers, cause the one or more computers to perform the method of claim 1.

15. A non-transitory computer storage medium encoded with instructions that, when executed by one or more computers, cause the one or more computers to perform the method of claim 6.

16. A non-transitory computer storage medium encoded with instructions that, when executed by one or more computers, cause the one or more computers to perform the method of claim 10.

17. An apparatus comprising processing circuitry configured to perform the method of claim 1.

18. An apparatus comprising processing circuitry configured to perform the method of claim 6.

19. An apparatus comprising processing circuitry configured to perform the method of claim 10.

20. One or more baseband processors configured to perform the method of claim 6.
